(19) United States
(12) Patent Application Publication
(10) Pub. No.: US 2021/0131406 A1
(43) Pub. Date: May 6, 2021

(54) ECCENTRIC CENTRIFUGAL FORCE GENERATOR

(71) Applicant: Michaelangelo VIANELLO, Saylorsburg, PA (US)

(72) Inventor: Michaelangelo VIANELLO, Saylorsburg, PA (US)

(21) Appl. No.: 17/259,328

(22) PCT Filed: Jul. 9, 2019
(86) PCT No.: PCT/US2019/000032

§ 371 Date: Jan. 11, 2021

Related U.S. Application Data
(60) Provisional application No. 62/763,974, filed on Jul. 11, 2018.

(51) Int. Cl. F03G 7/10; F03G 3/00

(52) U.S. Cl. CPC F03G 7/10; H02K 53/00; F03G 3/00

(57) ABSTRACT

Eccentric centrifugal force is a fictitious force that is centrifugal in nature but is focused and directional. It is generated by having the axis of rotation which is off-center or eccentric. The generating device can move three dimensionally and overcome other fictitious forces such as gravity or inertia. The generating device can be attached to other objects causing the other objects to move with the ECF device. Thus for example, an ECF device attached to a vehicle, such as a car, could move a car. Because ECF is three dimensional, an ECF device in a car can allow a car to fly. The ECF generator herein has a hub with a hole in it, a shaft that goes through the hole and a weight on the end of the shaft. The hub is off-centered (eccentric) in a race. The race forces the spindle to slide back and forth through the off-centered hubs thus providing an eccentric centrifugal force.

This application is a National Stage completion of PCT/US2019/000032 filed Jul. 9, 2019, which claims benefit of provisional application No. 62/763,974, filed Jul. 11, 2018.

### BACKGROUND OF THE INVENTION

In Newtonian mechanics, the centrifugal force is an inertial force (also called a “fictitious” or “pseudo” force) that appears to act on all objects when viewed in a rotating frame of reference. It is directed away from an axis passing through the coordinate system's origin and parallel to the axis of rotation. If the axis of rotation passes through the coordinate system's origin, the centrifugal force is directed radially outwards from that axis. The concept of centrifugal force can be applied in rotating devices, such as centrifuges, centrifugal pumps, centrifugal governors, and centrifugal clutches, and in centrifugal railways, planetary orbits and banked curves, when they are analyzed in a rotating coordinate system. The term has sometimes also been used for the reactive centrifugal force that may be viewed as a reaction to a centripetal force in some circumstances.” (Wikipedia) See FIG. 1.

An eccentric centrifugal force (ECF) is an inertial fictitious force that is focused and directional. It is created by a device where the axis of rotation is off-centered or eccentric. See FIGS. 2, 3, and 4.

### BRIEF SUMMARY OF THE INVENTION

Under Newton mechanics centrifugal force is an inertial, fictitious force on an object, FIG. 1 shows a standard centrifugal force device in which there is a hub (H), a spindle or shaft (S), and a weight (W). Spinning the hub creates a centrifugal force governed by the formula F=m*v²/r. Where “F” is the force, “m” is the mass or weight, “v” is the velocity, and “r” is the radius. The force is the same at any point of the circle circumscribed by the spinning weight, The force is not focused and it is not directional.

The force is the same at any point of the circle circumscribed by the spinning weight.

The eccentric centrifugal force (ECF) generator creates a centrifugal force which is focused and directional.

An ECF generator is shown in FIGS. 2, 3, and 4.

FIG. 2 shows an eccentric centrifugal force generator. In FIG. 2, the hub is off-centered. Thus the radius is longer on one side than on the other side. This effect is produced because of the shape of the race R. The shape of the race forces the shaft to slide through the hub. Thus the direction and strength of the centrifugal force changes as the hub rotates.

The maximum force is delivered when the spindle shaft is at its longest point.

As the parameters of the diameter of the race and the shape of the race, the length of the spindle and mass of the weights, the speed of rotation of the hub, and so forth change, the strength and direction of the ECF changes.

Additional spindles and weights can be added to increase the strength of the ECF.

The eccentric centrifugal force (ECF) generator creates a centrifugal force which is focused and directional.

The ECF device can be built with any material including but not limited to wood, metal, plastic, styrofoam, rubber, etc.

### BRIEF DESCRIPTION OF THE DRAWINGS

FIG. 1, shows a standard centrifugal force device in which there is a hub (H), a spindle or shaft (S), and a weight (W). Spinning the hub creates a centrifugal force governed by the formula F=m*v²/r, where F is the force, m is the mass or weight, v is the velocity, and r is the radius.

The force is the same at any point of the circle circumscribed by the spinning weight.

FIG. 2 shows an eccentric centrifugal force generator according to the present invention. In FIG. 2, the hub is off-centered. Thus the radius is longer on one side than on the other side. This effect is produced because of the shape of the race R. The shape of the race forces the shaft to slide through the hub. Thus the direction and strength of the centrifugal force changes as the hub rotates. The maximum force is delivered when the spindle shaft is at its longest point.

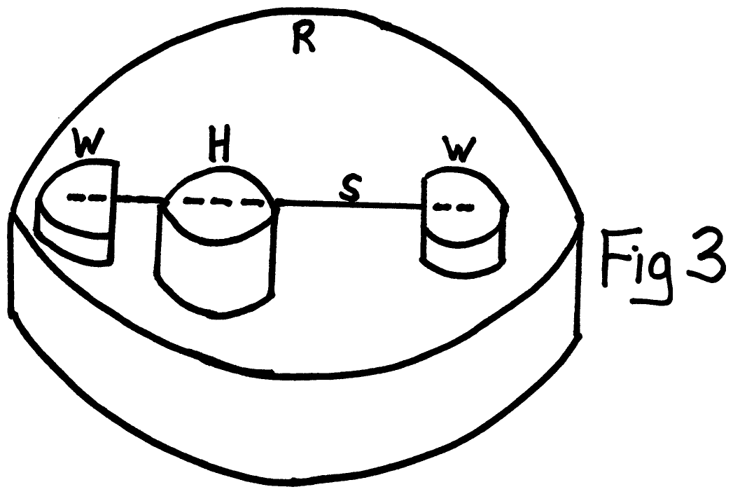

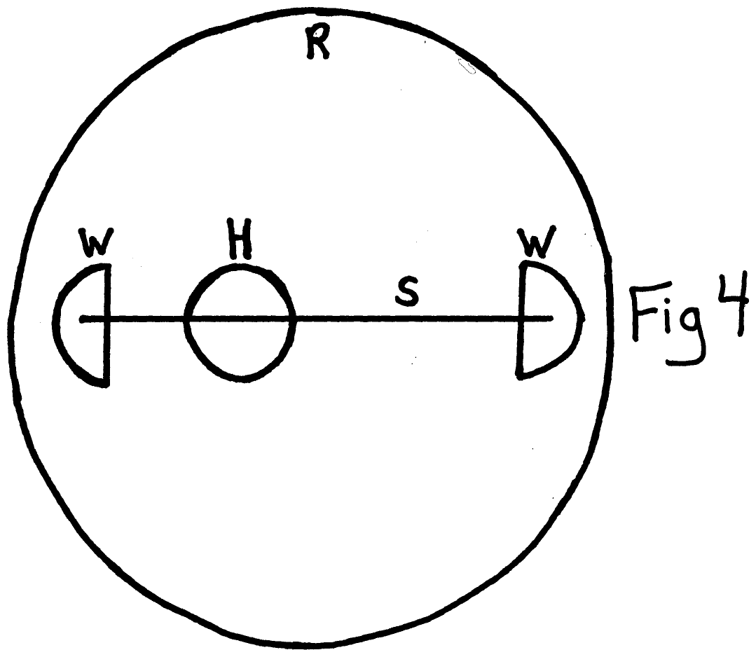

As the parameters of the diameter and the shape of the race, the length of the spindle, the weights, the speed of rotation of the hub, and so forth change, the strength and direction of the ECF changes. The reason for that is when the spindle is in the position as shown in FIG. 2 the weight to the right is at the furthest point from the hub, thus providing the longest radius and the maximum centrifugal force at that point. As the hub rotates, the race forces the weight to push the spindle through the hub thus decreasing the radius of the circumscribed circle and thus changing the amount of centrifugal force being generated. As the spindle moves closer to the hub the radius of the circumscribed circle thus the centrifugal force is less. As the hub continues to spin around, the weight that was on the left of FIG. 2 pushes outward from the hub pulling the spindle outward from the hub and increasing the radius of the circumscribed circle. As it reaches the outside of the race to the right of FIG. 2 it draws the spindle outward from the hub making a larger circumscribed circle. Thus increasing the focused directional centrifugal force to its maximum.

Additional spindles and weights can be added to increase the strength of the ECF. The spindle need have only one weight on it.

The hub has a hole going through it.

The eccentric centrifugal force (ECF) generator (the invention) creates a centrifugal force which is focused and directional.

The weights moving back and forth as the hub rotates create a Newton's third law effect.

FIG. 3 is a side view of FIG. 2.

FIG. 4 is similar to FIG. 2 except here the spindle lays across the top of the hub in a groove rather than through a hole in the side of the hub.

### DETAILED DESCRIPTION OF THE INVENTION

The eccentric centrifugal force (ECF) generator (the invention) creates a centrifugal force which is focused and directional.

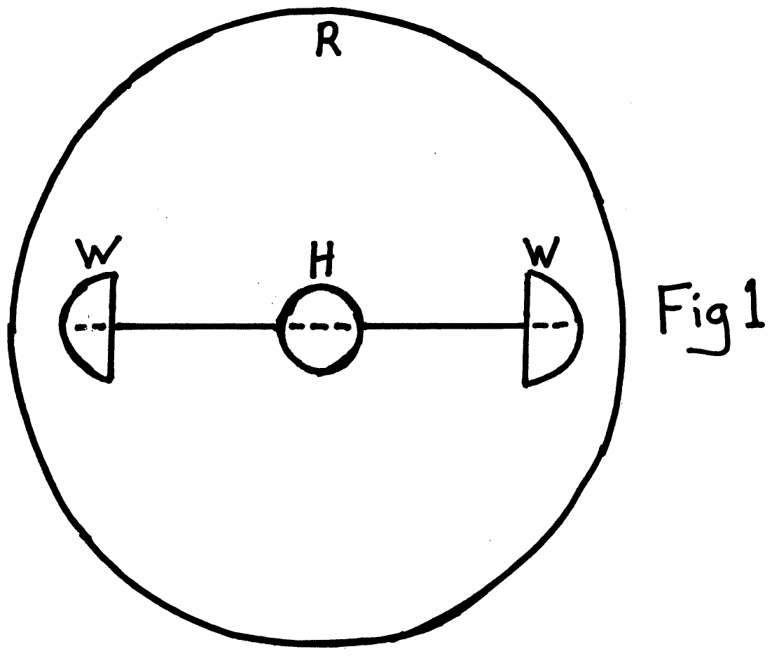

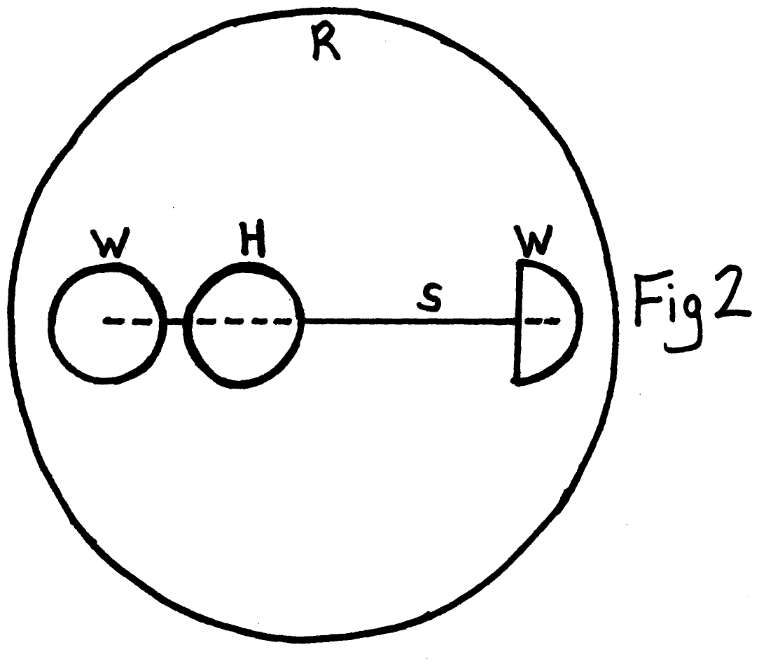

FIG. 1 shows a standard centrifugal force device in which there is a hub (H), a spindle or shaft (S), and a weight (W). Spinning the hub creates a centrifugal force governed by the formula F=m*v²/r. Where F is the force, m is the mass or weight, v is the velocity, and r is the radius.

The centrifugal force is the same at any point of the circle circumscribed by the spinning weight. There also is a reactive centripetal force.

FIGS. 2, 3, and 4 show an eccentric centrifugal force generator. In FIGS. 2, 3, and 4 the hub is off-centered. Thus the radius is longer on one side than on the other side. This effect is produced because of the shape of the race. The shape of the race forces the shaft to slide through the hole drilled in the hub. Thus the direction and strength of the centrifugal force changes as the hub rotates.

The maximum centrifugal force is delivered when the spindle shaft is at the point where the radius of rotation is at its maximum.

As the parameters of the diameter of the race, the length of the spindle, the weights, the speed of rotation of the hub, and so forth change, the strength and direction of the ECF changes.

Additional spindles and weights can be added to increase the ECF.

The ECF can add to or subtract from “fictitious forces” applied to the device and or real forces. For example, the ECF can overcome inertia to move an object along the surface—such as to move a car along a roadway. (Newton's first law)

ECF can be used to move an object, such as a car, up an inclined plane—thus overcoming gravity.

If the ECF device is pointed vertically, it can lift itself and to whatever it is attached off the surface, thus overcoming gravity. If the object to which the ECF is attached is a car, the ECF device can make the car fly.

If the ECF device is in space it can move itself and to whatever it is attached in any direction. If such a spacecraft uses an electric motor to drive the ECF device, and a solar generator to produce the electricity, the device could travel through space forever and reach the speed of light.

If two ECF devices are put together at right angles to each other, the combined device can move three dimensionally, backward, forward, left, right, up, or down (XYZ). If three ECF devices are put together at right angles to each other in three dimensional space (XYZ) this gives better control over moving the combined devices in any direction in three-dimensional space.

Using a control such as a remote control or a hard wired control gives one better control over the movement of the combined ECF device by letting the user control the speeds of the motors.

The hub may be rotated by anything that can rotate it, such as an electrical motor, internal combustion engine, steam, or jets, etc.

1-6. (canceled)

7. An eccentric centrifugal force generator, said generator comprising
a rotatable hub,
a spindle passing through the hub,
at least one weight mounted on the spindle, and
a race eccentric with respect to the hub,
whereby, as the hub rotates, the race moves the weight with respect to the hub, generating focused and directional centrifugal force.

8. The centrifugal force generator of claim 7, wherein the strength and direction of the eccentric centrifugal force can be varied by changing at least one of:
the rotation speed of the hub,
the length of the spindle,
the mass of the weight(s),
the number of spindles,
the number of weights,
the shape of the race.

9. The centrifugal force generator of claim 7, wherein the generator can be pointed in any direction in three-dimensional space, to produce thrust in that direction.

10. The centrifugal force generator of claim 7, wherein the generator is attached to a vehicle to propel the vehicle.

11. The centrifugal force generator of claim 10, wherein the vehicle is selected from the group consisting of automobiles, aircraft and watercraft.

12. The centrifugal force generator of claim 11, wherein said watercraft are selected from the group consisting of submarines and surface vessels.

13. The centrifugal force generator of claim 7, wherein the eccentric centrifugal force is a fictitious force that can overcome other fictitious forces, and real forces.

14. The centrifugal force generator of claim 7, wherein the other fictitious forces include inertia, centrifugal force, and gravity.
